(19) United States
(12) Patent Application Publication
(10) Pub. No.: US 2009/0064890 A1
(43) Pub. Date: Mar. 12, 2009

(54) Installation for transporting passengers embarked on board a vehicle, with two means for moving the vehicle

(75) Inventors: Stefano Charrere, Aosta (IT); Thierry Gayte, Pechabou (FR); Nicolas Revenant, Echirolles (FR)

Correspondence Address: OLIFF & BERRIDGE, PLC, P.O. BOX 320850, ALEXANDRIA, VA, 22320-4850, US

(73) Assignee: POMAGALSKI SA., Fontaine (FR)

(21) Appl. No.: 12/222,223

(22) Filed: Aug. 5, 2008

(30) Foreign Application Priority Data
Sep. 11, 2007 (FR) 07/06356

(51) Int. Cl. B61B 15/00; B61B 3/00; B61B 9/00; B61B 13/00; B61B 1/00; B66B 9/00

(52) U.S. Cl. 104/89; 104/173.1; 104/128; 187/250

(57) ABSTRACT

A transport installation comprises a first means for moving a vehicle between a first end terminal and an intermediate terminal and a second means for moving the vehicle between the intermediate terminal and a second end terminal, by loading the vehicle on board an elevator shaft. The first means for moving are formed by a people mover comprising an aerial rope in a closed loop for driving at least one detachable car forming said vehicle, said loop being equipped with a detachment/attachment section of the car situated near the intermediate terminal. The people mover also comprises a transfer track for guiding and transporting the car in the detached position. The transfer track comprises a mobile terminal section housed in the elevator shaft and equipped with a first individual drive means of the car, and a fixed connecting section equipped with a second individual drive means of the car and connecting the detachment/attachment section and the terminal section when the elevator shaft is in the intermediate terminal.

### BACKGROUND OF THE INVENTION

The invention relates to an installation for transporting passengers embarked on board a vehicle, comprising:
an intermediate terminal arranged between a first and second end terminals,
first means for moving the vehicle between the first end terminal and the intermediate terminal along a first path, by coupling the vehicle to a hauling rope,
and second means for moving the vehicle between the intermediate terminal and the second end terminal along a second path substantially perpendicular to the first path near the intermediate terminal, by loading the vehicle on board an elevator shaft.

### STATE OF THE ART

This type of installation is advantageous when public transport of passengers has to be performed with two combined horizontal and vertical movements. The document ITMI20000726 describes such an installation where the first moving means is a funicular with horizontal travel. The funicular car, guided by rails installed on the ground, is moved by a hauling rope actuated by a power unit. The second means for vertical movement of the car involves loading the car on board an elevator shaft. To achieve this, the floor of the elevator shaft is provided with a rail section and the hauling rope hauls the car up to this rail section to load it into the elevator shaft when the latter is in the intermediate terminal.

The above installation is not however totally satisfactory. The hauling rope associated with a car does in fact have to be stopped throughout the period of back-and-forth movement of the elevator to wait for the car. All the cars connected to this rope are then stopped to the detriment of the installation throughput capacity, which is moreover liable to generate a reaction from the passengers when people movers are involved.

To meet throughput capacity requirements, it can be envisaged to multiply the number of guide rails, the number of hauling ropes and the number of elevator shafts. Such a solution does however remain delicate to implement and requires additional power units and synchronization and safety systems, which is accompanied by an increase of manufacturing and maintenance costs that is often prohibitive.

### OBJECT OF THE INVENTION

The object of the invention consists in providing an installation for transporting passengers embarked on board a vehicle, guaranteeing a high throughput in simple and reliable manner.

The installation according to the invention is remarkable in that the first means for moving are formed by a people mover comprising:
an aerial rope in a closed loop for driving at least one detachable car constituting said vehicle, said loop being equipped with a detachment/attachment section of the car situated near the intermediate terminal,
a transfer track for guiding and transporting the car in the detached position comprising a mobile terminal section housed in the elevator shaft and equipped with a first individual drive means of the car, and a fixed connecting section equipped with a second individual drive means of the car and connecting the detachment/attachment section and the terminal section when the elevator shaft is in the intermediate terminal.

Unlike the prior art where operation of the first means for moving the vehicle was governed by the second means for moving, operation of the people mover of the installation according to the invention is totally dissociated from that of the second means for moving due to the detachment/attachment performed up-line from the elevator shaft which allows movement of the hauling rope independent from movement of the elevator shaft. The people mover and the elevator shaft can thus operate independently from one another. The regularity of operation of the people mover is not affected, because movement of the people mover cars coupled to the hauling rope can take place during the periods of back-and-forth movement of the elevator shaft. To prevent any risk of collision, only a coordinating means may prove necessary between the car leaving the second means for moving and the car that is about to be taken up by the second means for moving. Such a coordination can be achieved by modulation (if necessary) of the running speed of the hauling rope, or by a special arrangement of the transfer track with, for example, a storage section parallel to the connecting section and connected to the latter at the ends by switching systems.

According to a preferred embodiment, the first individual drive means comprise a first set of wheels with pneumatic tires, one of which wheels is coupled to an electric motor integral to the elevator shaft, said first set of wheels being equipped with first transmission means whereby each wheel is made to rotate by one of the adjacent wheels at equal circumferential speeds.

Other technical features can be used either alone or in combination:
the second individual drive means comprise a second set of wheels with pneumatic tires, one of which wheels is coupled to a second electric motor or to a power take-off derived from the rope, said second set of wheels being equipped with second transmission means whereby each wheel is made to rotate by one of the adjacent wheels,
the second set of wheels is subdivided into a first and second successive parts respectively adjacent to the terminal section and to the detachment/attachment section, in which the second transmission means make the wheels of the first part rotate at equal circumferential speeds, and make the wheels of the second part rotate at increasing circumferential speeds in the direction of the detachment/attachment section,
the elevator shaft comprises means for positioning the car and for keeping same in position with respect to said elevator shaft according to a predefined positioning,
the people mover is a detachable monocable gondola car where the closed loop formed by the rope comprises two parallel running tracks of back-and-forth type each comprising two parallel hauling-carrying strands moving in synchronism and a detachment/attachment section at its end near the second means for moving,
the second means for moving comprise two elevator shafts each associated with one of the detachment/attachment sections by a respective transfer track.

### BRIEF DESCRIPTION OF THE DRAWINGS

Other advantages and features will become more clearly apparent from the following description of a particular embodiment of the invention given for non-restrictive example purposes only and represented in the accompanying drawings, in which:

FIG. 1 represents a front view of the intermediate terminal, the second end terminal, the second means for moving and a part of the first means for moving of an example of a transport installation according to the invention,

FIG. 2 is a right-side view of the elements of FIG. 1,

FIG. 3 is a left-side view of the elements of FIGS. 1 and 2,

FIG. 4 is a top view of the intermediate terminal,

FIG. 5 represents a front view of the first end terminal of the transport installation of the previous figures,

FIG. 6 is a top view of the terminal of FIG. 5,

FIG. 7 illustrates the intermediate terminal in detail in front view.

### DESCRIPTION OF A PREFERRED EMBODIMENT OF THE INVENTION

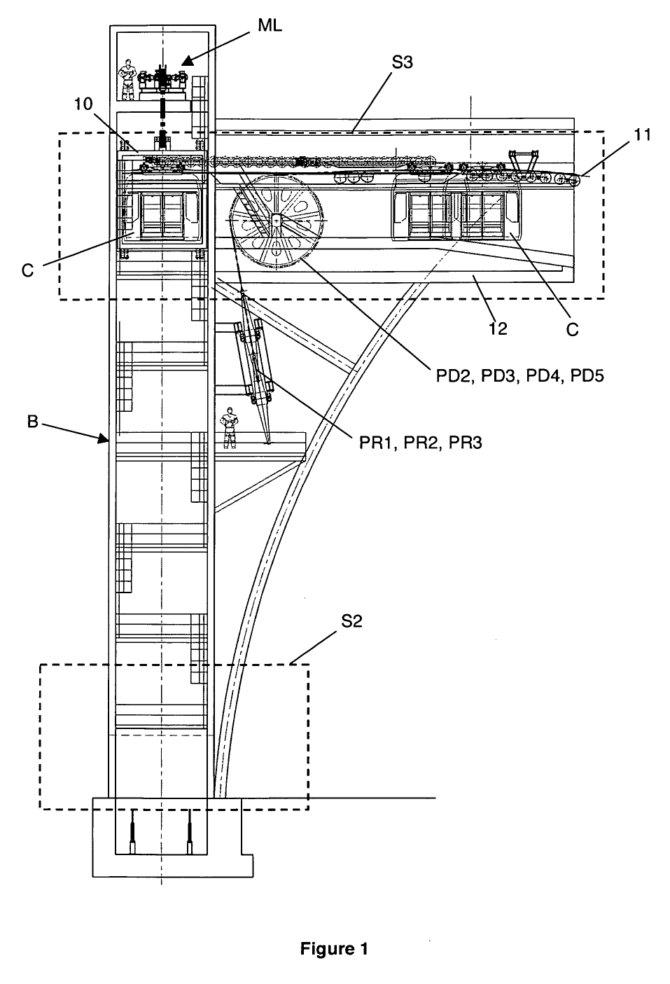

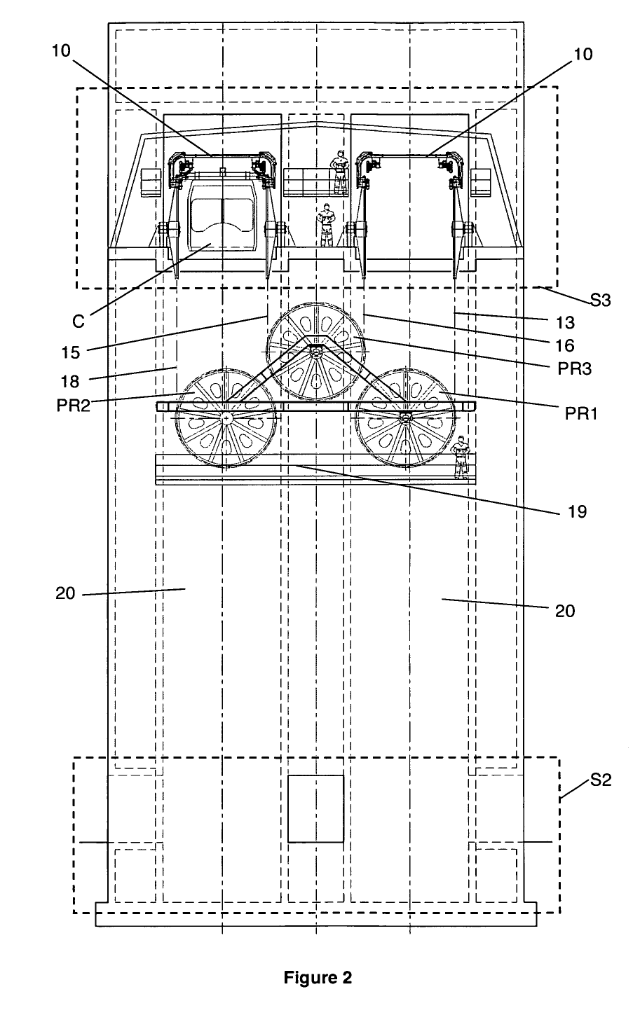

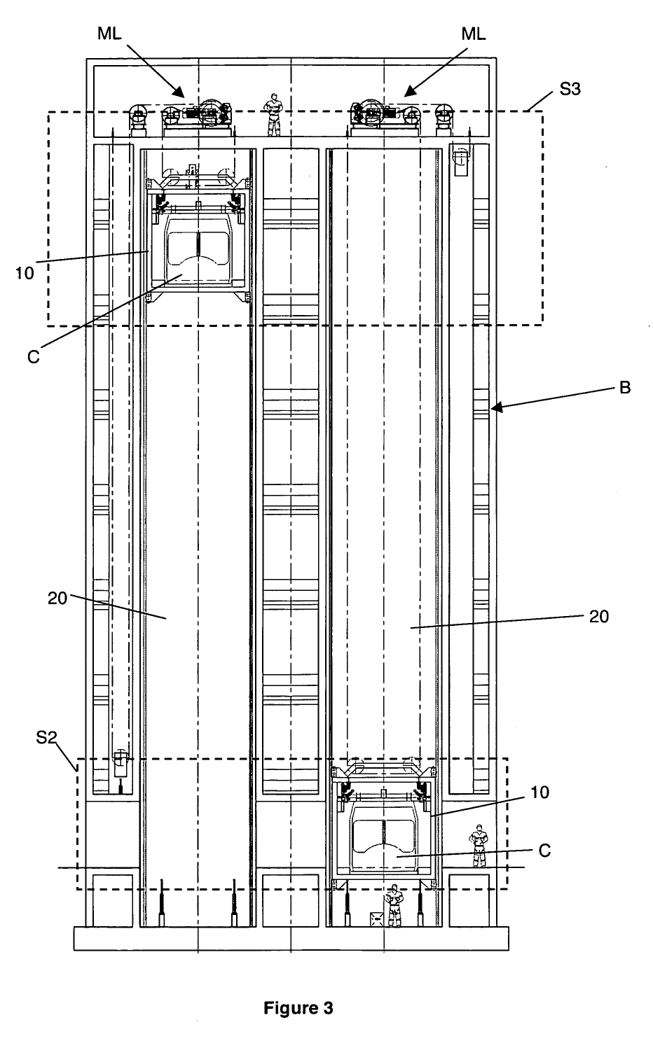

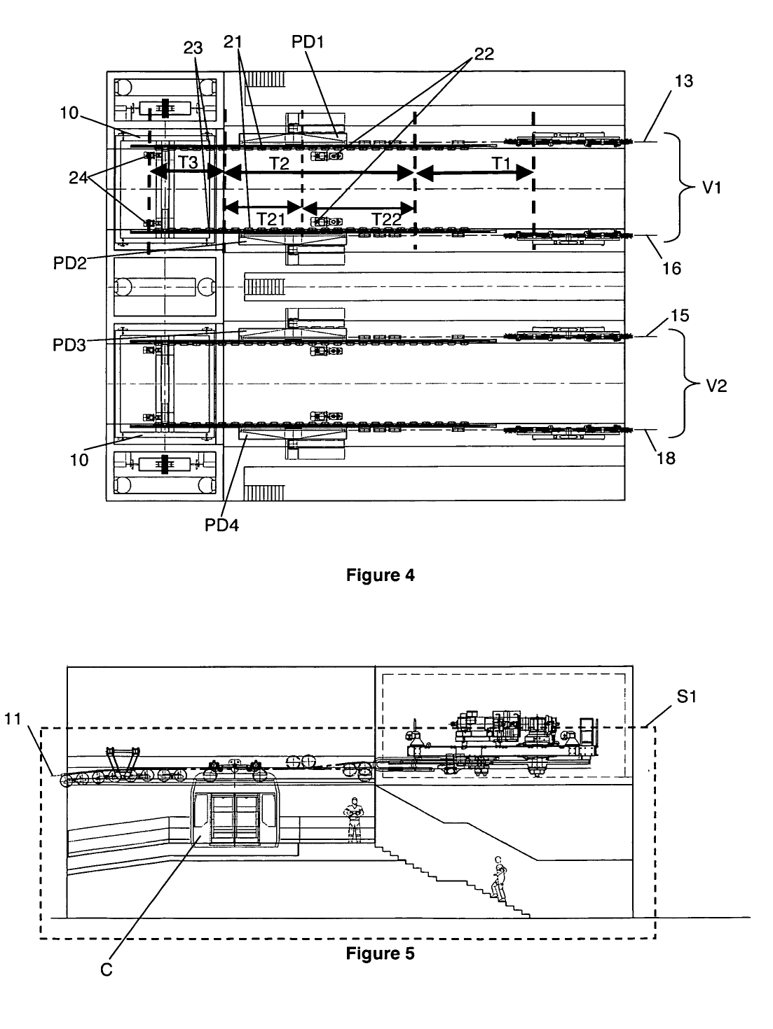

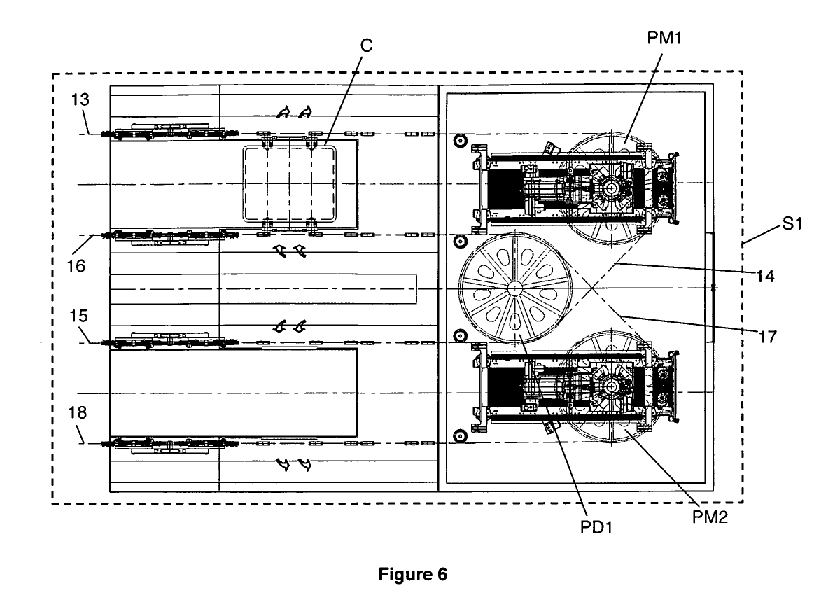

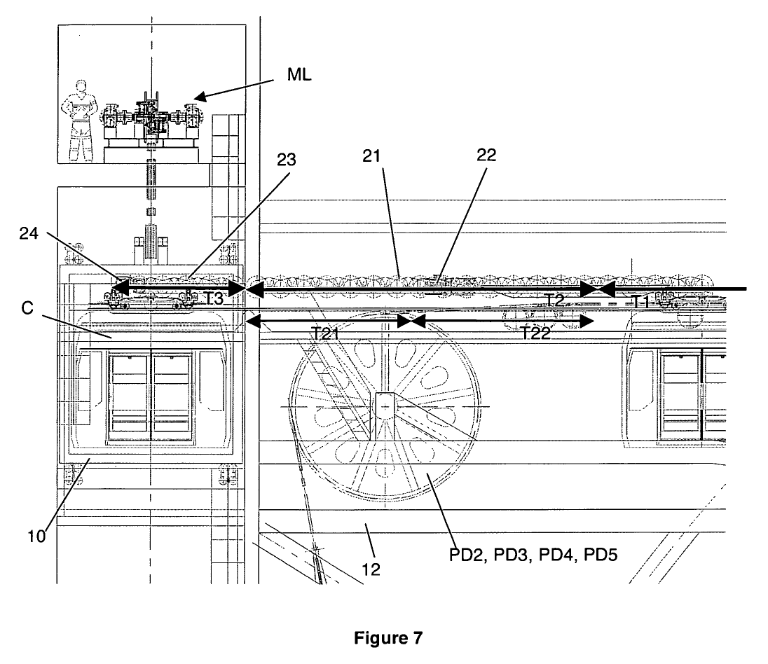

FIGS. 1 to 7 represent an example of a transport installation according to the invention designed for transporting passengers loaded on board vehicles formed here by detachable cars C for a people mover. The passengers are transported between a first end terminal S1 and a second end terminal S2 passing via an intermediate terminal S3. Intermediate terminal S3 is therefore arranged between end terminals S1, S2. Each car C is moved from first end terminal S1 (where the passengers can embark) to intermediate terminal S3 (where disembarking and embarking may not be authorized), and then moved from intermediate terminal S3 to second end terminal S2 (where the passengers can disembark and embark). After a predefined stopping time in terminal S2, car C undergoes the reverse movements until it returns to terminal S1 where the passengers loaded in terminal S2 can disembark during a predefined stopping time during which new passengers can embark in turn.

To ensure the movements of cars C, the transport installation comprises a first means for moving cars C between first end terminal S1 and intermediate terminal S3 along a first path. According to the remainder of the description, movement of each car C is achieved by detachable coupling of car C to a hauling rope of aerial type (hauling-carrying). Cars C are therefore of detachable type.

The installation also comprises second means for moving cars C between intermediate terminal S3 and second end terminal S2 along a second path. The second path is substantially perpendicular to the first path at least near intermediate terminal S3. According to the remainder of the description, movement of each car C is achieved by loading the latter on board an elevator shaft 10, intermediate terminal S3 being situated vertically to terminal S2 (above the latter in the figures). However movement of cars C by loading in an elevator shaft 10 can be envisaged whenever a difference of altitude between intermediate terminal S3 second terminal S2 has to be compensated. Terminal S2 can thus be situated above intermediate terminal S3, for example vertically above the latter, and the second path may not be straight, or may be obliquely straight.

Second end terminal S2 is arranged on the ground floor of a mainly vertical building B, whereas intermediate terminal S3 is located at the top of building B. The part of building B, intermediate between terminals S2 and S3, internally delineates two vertical passages 20 along which two independent elevator shafts 10 are moved, each one being moved with a back-and-forth movement. Intermediate terminal S3 houses a lifting mechanism ML associated with each of elevator shafts 10. The second means for moving therefore comprises two elevator shafts 10.

The first means for moving cars C between first end terminal S1 and intermediate terminal S3 is formed by a people mover which consists, in the illustrated example, of a detachable monocable gondola car comprising a single aerial rope 11 arranged in a closed loop so as to form two successive loops each connecting first end terminal S1 and intermediate terminal S3. Hauling-carrying rope 11 is actuated with a running movement to perform driving of detachable cars C in the engaged position at least along a part of the closed loop.

To achieve such an arrangement with two successive loops, terminal S1 comprises two driving pulleys PM1, PM2 and a first idle-mounted diverting pulley PD1. These three pulleys PM1, PM2 and PD1 with substantially vertical axes are arranged at the apex of a triangle in such a way that diverting pulley PD1 is in a central position and driving pulleys PM1 and PM2 are laterally offset on each side of pulley PD1. Driving pulleys PM1 and PM2 drive aerial rope 11 at the same speed. Intermediate terminal S3 for its part comprises a first, second and third return pulleys respectively referenced PR1, PR2, PR3. These three pulleys PR1, PR2, PR3 are arranged at the apex of a triangle in such a way that return pulley PR3 is in a central position and return pulleys PR1 and PR2 are laterally offset on each side of pulley PR3.

Aerial rope 11 extends in a closed circuit between this set of six pulleys so as to successively have:
a first hauling-carrying strand 13 extending between first return pulley PR1 and first driving pulley PM1,
a first joining strand 14 extending between first driving pulley PM1 and first diverting pulley PD1,
a second hauling-carrying strand 15 extending between first diverting pulley PD1 and third return pulley PR3,
a third hauling-carrying strand 16 extending between third return pulley PR3 and first diverting pulley PD1,
a second joining strand 17 extending between first diverting pulley PD1 and second driving pulley PM2,
a fourth hauling-carrying strand 18 extending between second driving pulley PM2 and second return pulley PR2,
and a third joining strand 19 extending between second return pulley PR2 and first return pulley PR1.

First diverting pulley PD1 can be a double-groove monoblock pulley or a stack of two independent coaxially-mounted single-groove pulleys. The angular diversion performed by third return pulley PR3 is equal to 180 degrees between second and third hauling-carrying strands 15, 16. First and third hauling-carrying strands 13, 16 are parallel and at the same level on the line, adjacent and driven together in synchronism. The same is the case for second and fourth hauling-carrying strands 15, 18, but in the opposite direction.

The closed loop formed by rope 11 thus comprises two parallel running tracks V1, V2 of back-and-forth type. Each track V1, V2 comprises two parallel hauling-carrying strands 13, 15, 16, 18 moving in synchronism. The installation comprises two cars C only, each of which is associated with one of the tracks V1, V2. A given car C always moves on the same track V1, V2 by simultaneous coupling with the two hauling-carrying strands 13, 15, 16, 18, in a back-and-forth movement achieved by reversing the direction of rotation of driving pulleys PM1, PM2. The opposite movements on one and the same track V1, V2 are interrupted in terminal S1 by the stopping time of car C to load and unload passengers, and in intermediate terminal S3 by the time required for car C to go back and forth to terminal S2.

Each track V1, V2 is associated with a respective elevator shaft 10: a given track V1, V2 always conveys its car C to the same elevator shaft 10 by means of a respective transfer track. For car C moving on a track V1, V2 to be able to engage on the corresponding transfer track (or vice-versa), each of tracks V1, V2 comprises a detachment/attachment section T1 at its end near the second means for moving, i.e. near corresponding elevator shaft 10. Each elevator shaft 10 is therefore associated with one of detachment/attachment sections T1 by a respective transfer track. When movement takes place from terminal S1 to terminal S2, the transfer track located between a given track V1, V2 and associated elevator shaft 10 performs transfer of car C in the detached position after running on detachment/attachment section T1, until car C is completely loaded inside elevator shaft 10. In the opposite way, when running from terminal S2 to terminal S1, the transfer track located between a given track V1, V2 and associated elevator shaft 10 performs transfer of car C in the detached position from inside elevator shaft 10 to detachment/attachment section T1 where car C is again coupled to aerial rope 11.

Building B comprises a horizontal platform 12, at the level of intermediate terminal S3, in which the two transfer tracks are partially housed. Platform 12 belongs to intermediate terminal S3.

Each hauling-carrying strand 13,15,16,18 is also engaged in a respective diverting pulley of horizontal axis arranged transversely to the running direction of aerial rope 11. These diverting pulleys are respectively referenced PD2, PD3, PD4, PD5 and are mounted idle inside horizontal platform 12. Second diverting pulley PD2 performs angular diversion of first hauling-carrying strand 13. Third diverting pulley PD3 performs angular diversion of third hauling-carrying strand 16. Fourth diverting pulley PD4 performs angular diversion of second hauling-carrying strand 15. Fifth diverting pulley PD5 performs angular diversion of fourth hauling-carrying strand 18.

The diversions, performed downwards by diverting pulleys PD2 to PD5, imply a separation of the pair of hauling-carrying strands 13, 15, 16, 18 of a given track V1, V2 corresponding to the clearance required for car C to pass. If this separating distance is smaller on the line, strands 13, 15, 16, 18 simply have to be diverted laterally between detachment/attachment section T1 and pulleys PD2 to PD5. Strands 13, 15, 16, 18, which extend before pulleys PD2 to PD5 in a substantially horizontal plane, switch to a vertical or inclined plane, and return pulleys PR1 to PR3 are arranged in this vertical or inclined plane. Return pulleys PR1 to PR3 are mounted idle on building B, outside building B, below platform 12. Hauling-carrying strands 13, 15, 16, 18 are kept taut by hydraulic jacks or counterweights, or any other equivalent system, acting on return pulleys PR1 to PR3.

Correct operation of people mover relies partially on synchronous driving of hauling-carrying strands 13, 15, 16, 18. Driving of pulleys PM1 and PM2 is performed either by identical electric motors supplied by one and the same current source by means of an electric differential system, or by a mechanical differential system driven by a single electric motor.

Each transfer track performs guiding and transportation of car C in the detached position from detachment/attachment section T1 to elevator shaft 10, and vice-versa. For this purpose, it comprises a fixed connecting section T2 performing the junction between detachment/attachment section T1 and the entrance to elevator shaft 10, when shaft 10 is positioned in intermediate terminal S3.

Each transfer track also comprises a mobile terminal section T3 housed in shaft 10 in alignment and in discontinuity with connecting section T2. Terminal section T3 performs guiding and transportation of car C from the entrance to shaft 10 until car C is completely loaded inside shaft 10, and vice-versa.

In this way, each transfer track comprises a mobile terminal section T3 housed in corresponding elevator shaft 10 and a fixed connecting section T2 connecting corresponding detachment/attachment section T1 and said terminal section T3, when elevator shaft 10 is in intermediate terminal S3. To perform controlled movement of car C between the entrance to elevator shaft 10 and the inside of shaft 10, and vice-versa, terminal section T3 is equipped with a first individual drive means of car C. In the same way, to perform controlled movement of car C between the entrance to elevator shaft 10 and detachment/attachment section T1, and vice-versa, connecting section T2 is equipped with a second individual drive means of car C.

On the line, each detachable car C is coupled to the corresponding pair of hauling-carrying strands 13, 15, 16, 18 by a carriage with detachable grips. At the entrance to intermediate terminal S3, car C is detached from the two strands by opening of the grips along detachment/attachment section T1. It is then slowed down and then moved at reduced speed along the transfer track to the inside of elevator shaft 10. For this purpose, detachment/attachment section T1 is equipped with a detachment mechanism (not shown), consisting for example of a control ramp of the detachable grips making the latter open resulting in car C being detached from strands 13, 15, 16, 18.

For a car C in the detached position to be able to move along a predefined path, its carriage is equipped with at least one pair of laterally offset sheaves. each sheave is securedly affixed to a grip. Connecting section T2 of each track V1, V2 is provided with carriage guiding means formed by a pair of parallel guide rails. Each guide performs guiding of a sheave of the pair during rolling of the latter. To achieve slowing-down and then movement at reduced speed, each detachable grip further comprises a friction track. Connecting section T2 of each track V1, V2 is provided with an individual drive means operating in conjunction with the friction tracks. For this purpose, the individual drive means comprise two parallel sets of wheels 21 with pneumatic tires. For each set of wheels 21, one of wheels 21 is coupled to an electric motor 22 or to a power take-off (not shown) derived from rope 11. Each set of wheels 21 is also equipped with transmission means whereby each wheel 21 is made to rotate by one of the adjacent wheels 21.

With a similar objective, terminal section T3 of each track V1, V2 comprises a pair of parallel guide rails and two parallel sets of wheels 23 with pneumatic tires. The two sets of wheels 23 constitute the individual drive means which equip terminal section T3. For each set, one of wheels 23 is coupled to an electric motor 24 securedly affixed to elevator shaft 10. Each set of wheels is also equipped with transmission means whereby each wheel 23 is made to rotate by one of the adjacent wheels 23 at equal circumferential speeds. Loading of car C on board elevator shaft 10, and inversely unloading thereof in the direction of connecting section T2, are achieved by suitable control of the speed of rotation of electric motor 24.

The guide rails of connecting section T2 are in alignment and in discontinuity with the guide rails of terminal section T3. In similar manner, each set of wheels 21 of connecting section T2 is in alignment and in discontinuity with one of the sets of wheels 23 of terminal section T3.

The transmission means equipping connecting section T2 are formed by a pair of auxiliary pulleys mounted coaxially on each wheel 21 of the set and operating in conjunction with belts, or by a pinion mounted coaxially on each wheel 21 of the set and operating in conjunction with idle pinions fitted between two wheel pinions. The same is the case for the transmission means equipping terminal section T3.

The set of wheels 21 of connecting section T2 is subdivided into a first and second successive parts T21, T22 respectively adjacent to terminal section T3 and to detachment/attachment section T1. In the first part T21, the transmission means make wheels 21 rotate at equal circumferential speeds. In the second part T22 on the other hand, the transmission means make wheels 21 rotate at increasing circumferential speeds in the direction of detachment/attachment section T1. This feature ensures that car C is slowed down after it has been detached, or is speeded up before being coupled to rope 11. To perform coupling, each detachment/attachment section T1 also comprises an attachment mechanism (not shown), that is independent or not from the detachment mechanism, and that makes the grips close and performs engagement of car C on hauling-carrying strands 13, 15, 16, 18.

It is apparent from the above that the transport installation is equipped with two movement systems with parallel and independent operation, each comprising a running track V1, V2, a car C, a detachment/attachment section T1, a transfer track and an elevator shaft 10. To constitute each movement system, the people mover comprises:
an aerial rope 11 in a closed loop for driving at least one detachable car C, said loop being equipped with a detachment/attachment section T1 of car C situated near intermediate terminal S3,
a transfer rack for guiding and transporting car C in the detached position, comprising a mobile terminal section T3 housed in the elevator shaft 10 and equipped with a first individual drive means of car C, and a fixed connecting section T2 equipped with a second individual drive means of car C and connecting detachment/attachment section T1 and terminal section T3 when elevator shaft 10 is in intermediate terminal S3.

The people mover comprises a single aerial rope 11 to constitute the two movement systems. For a better stability to side winds, each track V1, V2 comprises two hauling-carrying strands, which means that two successive loops each connecting intermediate terminal S3 and first end terminal S1 have to be made.

Furthermore, each elevator shaft 10 comprises means for positioning car C and for keeping same in position with respect to said elevator shaft 10 according to a predefined positioning. For this purpose, elevator shaft 10 can comprise jacks with lateral travel or jacks with longitudinal travel, the position of which jacks at end of travel corresponds to the required positioning of car C. In another alternative embodiment, elevator shaft 10 comprises a retractable centring device designed to operate in conjunction with a hole made under car C. Such means for positioning and keeping in position are designed to guarantee that the horizontal threshold tolerance and the vertical threshold tolerance imposed by administrative regulations applicable to elevator systems are complied with.

It is clear that the number of independently-operating elevator shafts 10 can be variable according to the required throughput capacity. For example, the installation may only comprise a single elevator shaft 10. In such an alternative embodiment, connecting section T2 separates at a point of its length into two branches connected to one another at one of their ends by a switching mechanism controlled by control means. The opposite end of one of the branches is connected to detachment/attachment section T1 of one of tracks V1, V2, and the opposite end of the other branch is connected to detachment/attachment section T1 of the other track V1, V2.

Without departing from the scope of the invention, the people mover described above can be replaced by:
a detachable monocable gondola car where the single hauling-carrying rope is arranged in a closed loop with a single loop and with two unidirectional continuous running tracks of opposite directions each comprising a single hauling-carrying strand,
a closed-loop detachable monocable gondola car with two successive loops, formed by the aerial hauling-carrying rope comprising two parallel continuous running tracks of opposite directions each comprising two parallel hauling-carrying strands moving in synchronism,
a detachable gondola car with two hauling-carrying ropes each arranged in a closed loop with a single loop, the two loops being laterally offset to form two parallel unidirectional continuous running tracks of opposite directions each comprising two parallel hauling-carrying strands moving in synchronism,
a detachable gondola car with two hauling-carrying ropes each arranged in a closed loop with a single loop, the two loops being laterally offset to form two parallel running tracks of back-and-forth type each comprising two parallel hauling-carrying strands moving in synchronism,
a detachable gondola car having at least one carrying rope and at least one hauling rope arranged in a closed loop, said carrying and hauling ropes forming two parallel running tracks of back-and-forth type each comprising at least one carrying strand and at least one hauling strand,
a detachable gondola car having at least one carrying rope and at least one hauling rope arranged in a closed loop, said carrying and hauling ropes forming two parallel unidirectional continuous running tracks of opposite directions each comprising at least one carrying strand and at least one hauling strand.

Finally, whatever the embodiment of the people mover, the number of cars C driven by running of the aerial rope(s) can be more than two depending on the required throughput. With the same objective, the number of independently-operating elevator shafts 10 can be variable. Connecting section T2 can then comprise at least one section equipped with a switching mechanism controlled by control means to perform dispatching of cars C coming from detachment/attachment section(s) T1 to the different shafts 10. Moreover, the detachment mechanism and the attachment mechanism corresponding to a given detachment/attachment section T1 may be staggered along the closed loop formed by the rope(s) in the running direction. In this case, connecting section T2 has to comprise an additional switching mechanism. Connecting section T2 then separates at a point of its length into two branches connected to one another at one of their ends by said additional switching mechanism. The opposite end of one of the branches is connected to the detachment mechanism and that of the other branch is connected to the attachment mechanism.

1. An installation for transporting passengers embarked on board a vehicle, comprising:
an intermediate terminal arranged between a first and second end terminals,
first means for moving the vehicle between the first end terminal and the intermediate terminal along a first path, by coupling the vehicle to a hauling rope,
and second means for moving the vehicle between the intermediate terminal and the second end terminal along a second path substantially perpendicular to the first path near the intermediate terminal by loading the vehicle on board an elevator shaft,
wherein the first means for moving are formed by a people mover comprising:
an aerial rope in a closed loop for driving at least one detachable car forming said vehicle, said loop being equipped with a detachment/attachment section of the car situated near the intermediate terminal,
a transfer track for guiding and transporting the car in the detached position comprising a mobile terminal section housed in the elevator shaft and equipped with a first individual drive means of the car, and a fixed connecting section equipped with a second individual drive means of the car and connecting the detachment/attachment section and the terminal section when the elevator shaft is in the intermediate terminal.

2. The installation according to claim 1, wherein the first individual drive means comprise a first set of wheels with pneumatic tires, one of which wheels is coupled to an electric motor securedly affixed to the elevator shaft, said first set of wheels being equipped with first transmission means for making each wheel rotate by means of one of the adjacent wheels at equal circumferential speeds.

3. The installation according to claim 1, wherein the second individual drive means comprise a second set of wheels with pneumatic tires, one of which wheels is coupled to a second electric motor or to a power take-off derived from the rope, said second set of wheels being equipped with second transmission means whereby each wheel is made to rotate by one of the adjacent wheels.

4. The installation according to claim 3, wherein the second set of wheels is subdivided into a first and second successive parts respectively adjacent to the terminal section and to the detachment/attachment section, in which the second transmission means make the wheels of the first part rotate at equal circumferential speeds, and make the wheels of the second part rotate at increasing circumferential speeds in the direction of the detachment/attachment section.

5. The installation according to claim 1, wherein the elevator shaft comprises means for positioning the car and for keeping same in position with respect to said elevator shaft according to a predefined positioning.

6. The installation according to claim 1, wherein the people mover is a detachable monocable gondola car where the closed loop formed by the rope comprises two parallel running tracks of back-and-forth type each comprising two parallel hauling-carrying strands moving in synchronism and a detachment/attachment section at its end near the second means for moving.

7. The installation according to claim 6, wherein the second means for moving comprise two elevator shafts, each being associated with one of the detachment/attachment sections by a respective transfer track.

8. The installation according to claim 1, wherein the second end terminal is situated below and vertical to the intermediate terminal.

9. The installation according to claim 1, wherein the second end terminal is situated above and vertical to the intermediate terminal.
